(19) United States
(12) Patent Application Publication
(10) Pub. No.: US 2009/0255414 A1
(43) Pub. Date: Oct. 15, 2009

(54) GRILL APPARATUS

(76) Inventor: Hudson WANG, Kaohsiung Hsien (TW)

Correspondence Address: GREENBLUM & BERNSTEIN, P.L.C., 1950 ROLAND CLARKE PLACE, RESTON, VA, 20191, US

(21) Appl. No.: 12/101,312

(22) Filed: Apr. 11, 2008

(51) Int. Cl. A47J 27/00

(52) U.S. Cl. 99/446

(57) ABSTRACT

A grill apparatus includes: a housing; a grid disposed in the housing; a heating unit disposed below the grid within the housing for generating heat; a grease-collecting tray disposed below the heating unit; a grease-guiding tray disposed between the heating unit and the grease-collecting tray and formed with a central hole for passage of grease therethrough and into the grease-collecting tray; and a cover connected to the grease-guiding tray, covering the central hole in the grease-guiding tray, and cooperating with the grease-guiding tray to define a gap therebetween. The gap is in spatial communication with the central hole.

### BACKGROUND OF THE INVENTION

1. Field of the Invention

The invention relates to a grill apparatus, more particularly to a grill apparatus including a grease-collecting tray and a grease-guiding tray disposed above the grease-collecting tray for guiding grease into the grease-collecting tray.

2. Description of the Related Art

A conventional outdoor barbecue grill normally includes a drawable grease-collecting tray, such as those disclosed in U.S. Pat. Nos. 3,938,431, 4,662,349, and 4,899,725, disposed at a bottom of a grill housing for collecting grease and residue from foodstuff during barbecuing. However, since the barbecue grill is normally designed in a compact size, the distance between the grease-collecting tray and a heat source of the barbecue grill is not sufficient to avoid the safety concern that the grease collected in the grease-collecting tray may be undesirably ignited due to a high ambient temperature resulting from the heat source.

### SUMMARY OF THE INVENTION

Therefore, an object of the present invention is to provide a grill apparatus that can overcome the aforesaid drawback associated with the prior art.

Accordingly, a grill apparatus of the present invention comprises: a housing; a grid disposed in the housing; a heating unit disposed below the grid within the housing for generating heat; a grease-collecting tray disposed below the heating unit; a grease-guiding tray disposed between the heating unit and the grease-collecting tray and formed with a central hole for passage of grease therethrough and into the grease-collecting tray; and a cover connected to the grease-guiding tray, covering the central hole in the grease-guiding tray, and cooperating with the grease-guiding tray to define a gap therebetween. The gap is in spatial communication with the central hole.

### BRIEF DESCRIPTION OF THE DRAWINGS

Other features and advantages of the present invention will become apparent in the following detailed description of the preferred embodiments with reference to the accompanying drawings, of which:

FIG. 1 is an assembled perspective view of the first preferred embodiment of a grill apparatus according to the present invention;

FIG. 2 is a schematic side view to illustrate a state, where a grease-guiding tray of the first preferred embodiment is drawn out;

FIG. 3 is a schematic front view of the first preferred embodiment;

FIG. 4 is a perspective view of the grease-guiding tray of the first preferred embodiment;

FIG. 5 is a schematic side view of the second preferred embodiment of the grill apparatus according to the present invention, illustrating a state where the grease-guiding tray is drawn out;

FIG. 6 is a schematic front view of the second preferred embodiment; and

FIG. 7 is a perspective view of the grease-guiding tray of the second preferred embodiment.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

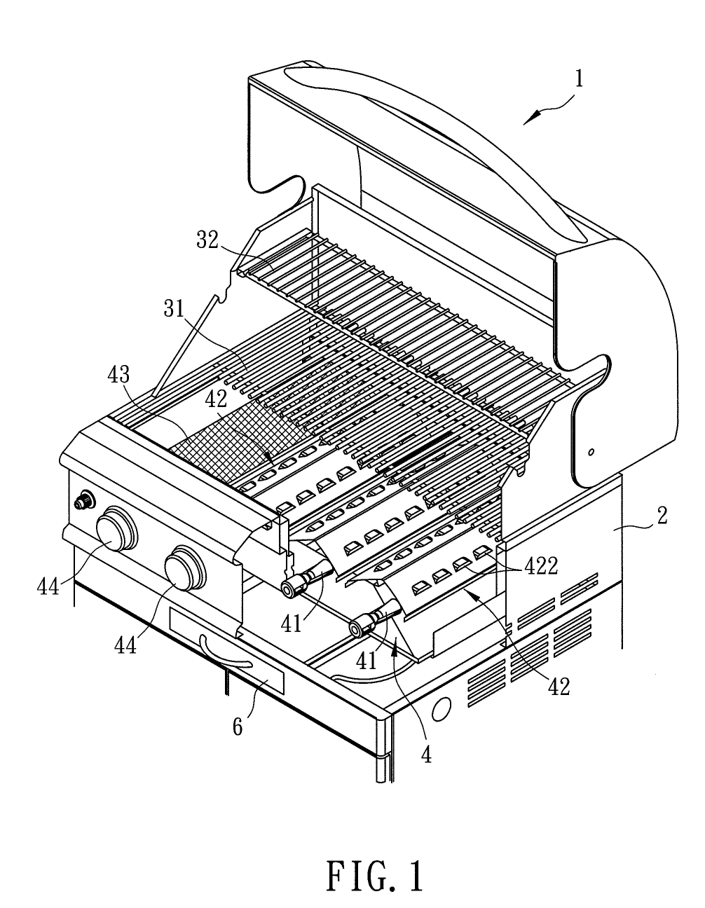

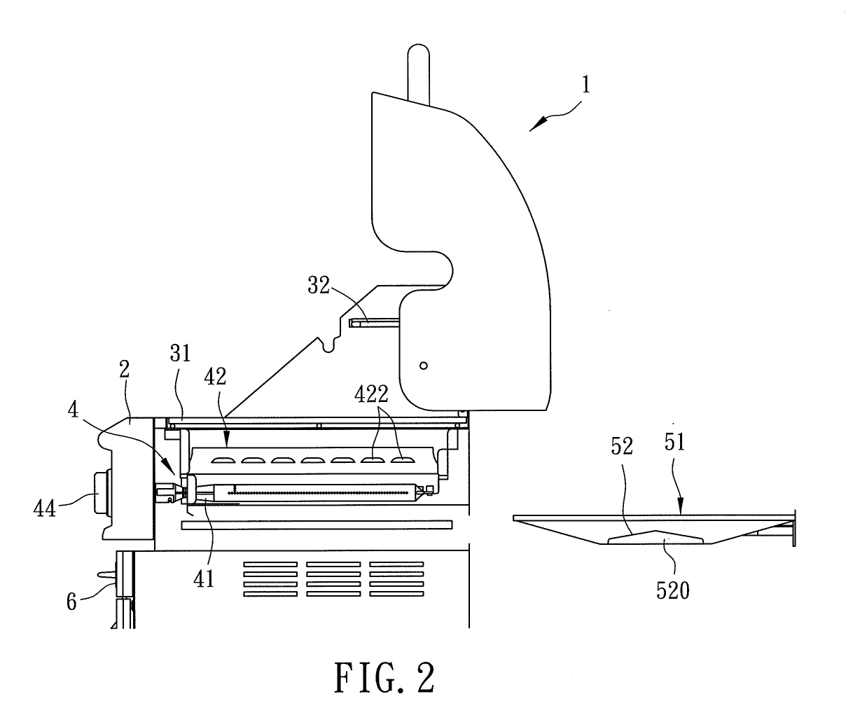

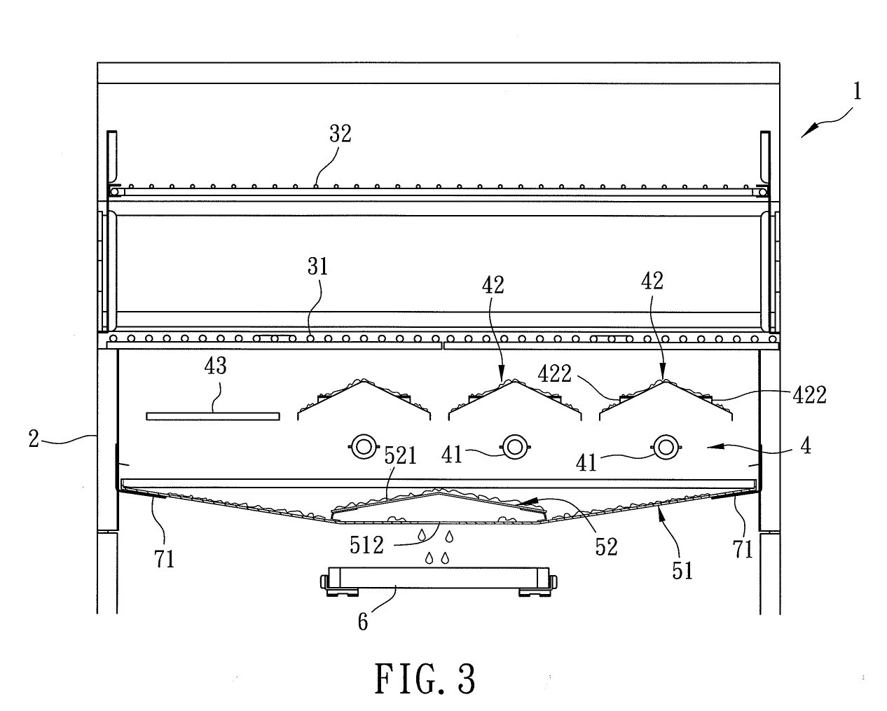

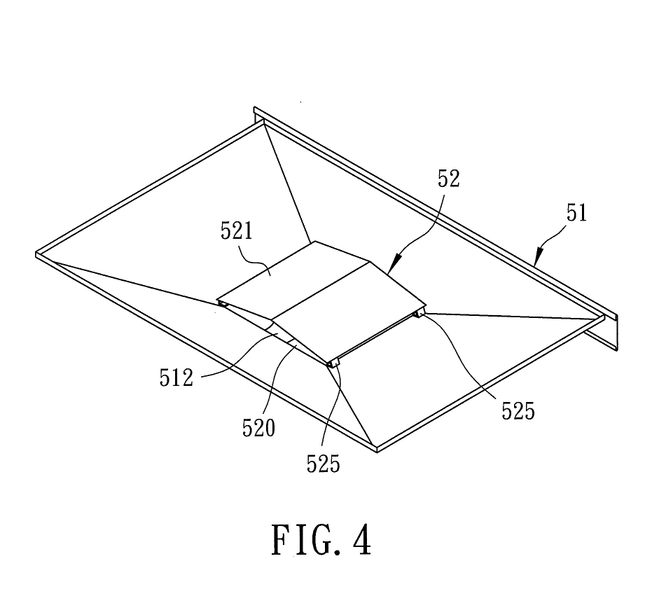

Referring to FIGS. 1 to 4, the first preferred embodiment of a grill apparatus 1 according to the present invention is shown to include: a housing 2; a grid 31 disposed in the housing 2; a heating unit 4 disposed below the grid 31 within the housing 2 for generating heat; a grease-collecting tray 6 disposed below the heating unit 4; a grease-guiding tray 51 disposed between the heating unit 4 and the grease-collecting tray 6 and formed with a central hole 512 for passage of grease therethrough and into the grease-collecting tray 6; and a cover 52 connected to the grease-guiding tray 51, covering the central hole 512 in the grease-guiding tray 51, and cooperating with the grease-guiding tray 51 to define a gap 520 therebetween. The gap 520 is in spatial communication with the central hole 512. The cover 52 is larger than the central hole 512 so that any grease drippings will not fall directly to the grease-collecting tray 6 or to the housing 2 if the grease-collecting tray 6 is not in place.

In this embodiment, the cover 52 includes a main plate 521 covering the central hole 512 and having an inverted V-shaped cross-section. The main plate 521 has a peripheral end. The cover 52 further includes a plurality of corner brackets 525 disposed between and secured to the peripheral end of the main plate 521 and the grease-guiding tray 51.

The grease-guiding tray 51 has a funneled shape. The grill apparatus 1 further includes a pair of guiding rails 71 provided on an interior of the housing 2. The grease-guiding tray 51 is mounted slidably on the guiding rails 71.

In this embodiment, the cover 52 is disposed above the central hole 512 in the grease-guiding tray 51.

The grill apparatus 1 further includes a food-supporting frame 32 disposed above the grill 31 for keeping cooked food, which are put thereon, warm before serving.

The heating unit 4 includes a plurality of tubular burners 41 disposed below the grid 31 and adapted to be connected to an external gas supply source. The heating unit 4 further includes a plurality of perforated plates 42 disposed above the tubular burners 4, respectively. Each of the perforated plates 42 has an inverted-V shape, and is formed with a plurality of air holes 422 for passage of air into the ambient of the respective tubular burner 41. The heating unit 4 further includes an infrared heater 43 disposed below the grid 31 for providing an alternative heating source. A plurality of gas control knobs 44 are provided for opening, closing, and regulating the gas flow rate in each of the tubular burners 41.

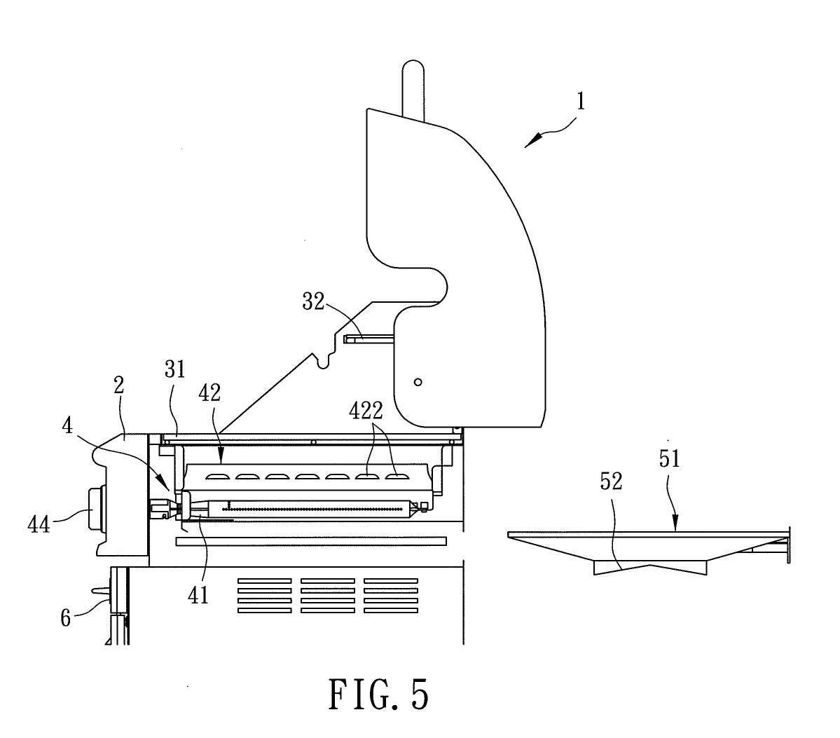

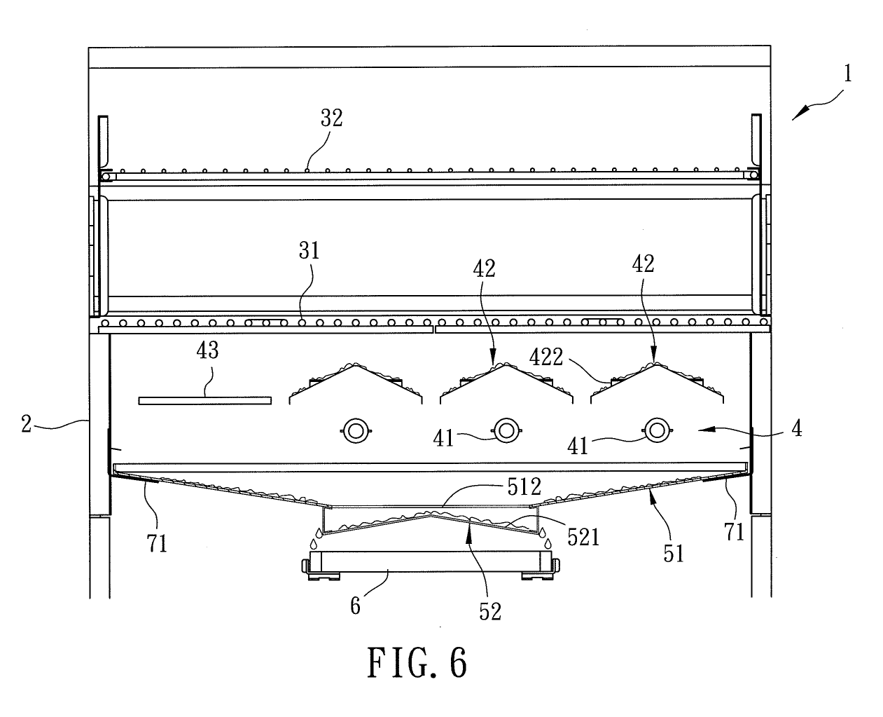

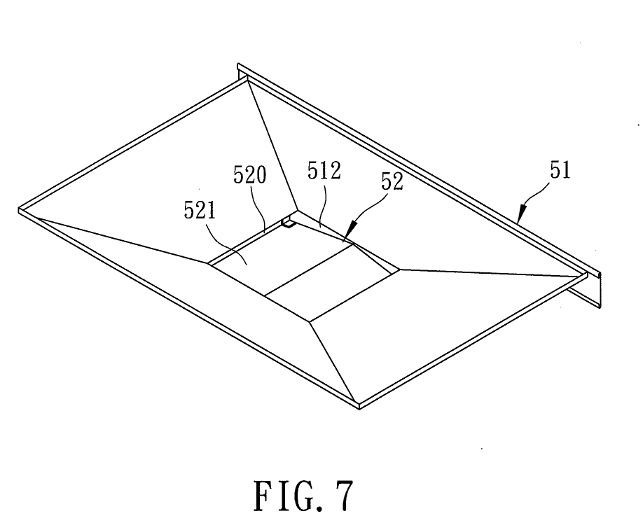

Referring to FIGS. 5 to 7, the second preferred embodiment of the grill apparatus of the present invention differs from the previous preferred embodiment in that the cover 52 is disposed below the central hole 512 in the grease-guiding tray 51.

With the inclusion of the grease-guiding tray 51 and the cover 52 in the grill apparatus 1 of this invention, the aforesaid drawback associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A grill apparatus comprising:
a housing;
a grid disposed in said housing;
a heating unit disposed below said grid within said housing for generating heat;
a grease-collecting tray disposed below said heating unit;
a grease-guiding tray disposed between said heating unit and said grease-collecting tray and formed with a central hole for passage of grease therethrough and into said grease-collecting tray; and
a cover connected to said grease-guiding tray, covering said central hole in said grease-guiding tray, and cooperating with said grease-guiding tray to define a gap therebetween, said gap being in spatial communication with said central hole.

2. The grill apparatus as claimed in claim 1, wherein said cover includes a main plate covering said central hole and having an inverted V-shaped cross-section.

3. The grill apparatus as claimed in claim 2, wherein said main plate has a peripheral end, said cover further including a plurality of corner brackets disposed between and secured to said peripheral end of said main plate and said grease-guiding tray.

4. The grill apparatus as claimed in claim 1, wherein said grease-guiding tray has a funneled shape.

5. The grill apparatus as claimed in claim 1, further comprising a pair of guiding rails provided on an interior of said housing, said grease-guiding tray being mounted slidably on said guiding rails.

6. The grill apparatus as claimed in claim 1, wherein said cover is disposed above said central hole in said grease-guiding tray.

7. The grill apparatus as claimed in claim 1, wherein said cover is disposed below said central hole in said grease-guiding tray.
